(19) United States
(12) Patent Application Publication
(10) Pub. No.: US 2018/0193933 A1
(43) Pub. Date: Jul. 12, 2018

(54) ABRASIVE WIRE FOR CUTTING SLICES FROM AN INGOT OF HARD MATERIAL

(71) Applicants: THERMOCOMPACT, Metz Tessy (FR); COMMISSARIAT A L'ENERGIE ATOMIQUE ET AUX ENERGIES ALTERNATIVES, Paris (FR)

(72) Inventors: Michel LY, Annecy (FR); Gerald SANCHEZ, Dingy Saint Clair (FR); Ludovic LAFLEUR, Talloires (FR); Xavier WEBER, Annecy (FR); Tifenn DECORPS, Villaz (FR)

(73) Assignees: THERMOCOMPACT, Metz Tessy (FR); COMMISSARIAT A L'ENERGIE ATOMIQUE ET AUX ENERGIES ALTERNATIVES, Paris (FR)

(21) Appl. No.: 15/736,600

(22) PCT Filed: Jun. 8, 2016
(86) PCT No.: PCT/FR2016/051366

§ 371 Date: Dec. 14, 2017

(30) Foreign Application Priority Data
Jun. 16, 2015 (FR) 1555519

(51) Int. Cl. B23D 61/18; B28D 5/04

(52) U.S. Cl. CPC B23D 61/185; B28D 5/045

(57) ABSTRACT

The invention relates to an abrasive wire which comprises: abrasive particles (32) of which the 5% minimum diameter, denoted D5, is no lower than 5 μm and of which the 95% maximum diameter, denoted D95, is less than 40 μm; and a binder (34) which mechanically holds the abrasive particles on a central core, the thickness of said binder being between Tbo_min and Tbo_max, where Tbo_min and Tbo_max are provided by the following relationships Tbo_max=D5×(1−Emin/100) and Tho_min=D95×(1−Emax/100), where Emin and Emax are, respectively, greater than 50% and less than 90%. The binder (34) has a hardness of greater than 450 Hv on the Vickers scale and the number of abrasive particles (32) per millimeter of wire is less than 31 and greater than 1 over at least 1 km of the length of the wire.

The invention relates to an abrasive wire for cutting slices from an ingot made of hard material. Another subject matter of the invention is a process for cutting slices from an ingot made of hard material.

In this description, a material is regarded as hard if its microhardness on the Vickers scale is greater than 400 HV or greater than or equal to 4 on the Mohs scale. In the case of the ingot, the Vickers microhardnesses are expressed for a loading of 50 grams-force, that is to say for a force of 0.49 N. For the other elements, a person skilled in the art knows that it is necessary to adjust the loading as a function of the thickness of the material on which the measurements are carried out in order for the size of the Vickers impression to be less than the thickness of the material.

Abrasive wires known for cutting slices for an ingot made of hard material comprise:
a central core, the diameter of which is between 0.05 mm and 0.15 mm,
abrasive particles, the 5% minimum diameter of the abrasive particles of which, denoted D5, is greater than or equal to 5 μm and the 95% maximum diameter of the abrasive particles of which, denoted D95, is less than 40 μm, the diameter D5 meaning that only 5% by volume of the abrasive particles have a diameter of less than this diameter D5 and the diameter D95 meaning that 95% by volume of the abrasive particles have a diameter of less than the diameter D95, the diameter of an abrasive particle being measured with a Coulter counter and corresponding to the diameter of the sphere which would have the same volume as the abrasive particle,
a binder which mechanically maintains the abrasive particles on the central core, the thickness of this binder being between Tbo_min and Tbo_max, where Tbo_min and Tbo_max are given by the following relationships Tbo_max=D5×(1−Emin/100) and Tbo_min=D95×(1−Emax/100), where Emin and Emax are respectively greater than 50% and less than 90%.

For example, the following are known from the state of the art:
WO2014/184456A1,
WO2014/004991A1,
WO2011/014884A1.

One of the important criteria for judging performance qualities of the abrasive wires is the precision of cutting slices. The precision of cutting slices is the inverse of the maximum variation in the thickness of the cut slice. In other words, the lower the variation in thickness of the cut slice, the more precise the abrasive wire is considered to be.

The invention is targeted at providing a more precise cutting wire. A subject matter of the invention is thus a cutting wire in accordance with claim 1.

The applicants have discovered that the combination of the different characteristics of the claimed abrasive wire makes it possible to decrease, by at least 10% and typically by more than 20%, the variations in thickness of the slices cut with such a wire. This result is all the more surprising as it goes against the teaching of the state of the art. For example, the experimental results of table 8 of the application WO2014/004991A1 show that the worst total thickness variation (TTV) is obtained with the lowest concentration of abrasive particles per millimeter (see section 306 or 310 of WO2014/004991A1). Furthermore, this same document explicitly indicates that the concentration of abrasive particles does not have much influence on the total thickness variation but that an increase in the concentration of abrasive particles improves the lifetime of the cutting wire (section 309).

Currently, the applicant company considers that the decrease in the thickness variations of the slices originates from the fact that the cutting power of the claimed wire remains substantially unvarying over its entire length during its use in a cutting device. This uniformity of the cutting power of this wire appears, in the current state of knowledge of the inventors, to be able to be explained by the combination of two complementary phenomena.

On the one hand, the use of a harder binder than those normally used limits the extent to which abrasive particles are torn off when they rub over the ingot.

On the other hand, in the cutting devices, the abrasive wire is displaced alternately in one direction and then in the opposite direction, so as to obtain a to-and-fro movement. For this, the wire is wound onto or alternatively unwound from a wind-off bobbin. The turns of the abrasive wire rub against one another on the wind-off bobbin, which significantly wears the wire. This is because each turn of the abrasive wire rubs directly against the abrasive particles of the other neighboring turns. By limiting the number of abrasive particles per millimeter, this rubbing of the turns on the abrasive particles of the neighboring turns is limited since the latter comprise fewer abrasive particles. Consequently, this may explain that to reduce the number of abrasive particles per millimeter makes it possible to maintain an invarying cutting power for a longer period of time.

The embodiments of this abrasive wire can comprise one or more of the characteristics of the dependent claims.

These embodiments of the abrasive wire additionally exhibit the following advantages:
To use fewer than twenty-five abrasive particles per millimeter makes it possible to reduce even more the variation in thickness of the cut slices and to increase the mean thickness of the slices obtained for the same spacing between the parallel sections of the wire which cut the ingot.
To use a binder, the hardness of which is greater than 500 HV on the Vickers scale, makes it possible to reduce even more the variations in thickness of the cut slices.
To use abrasive particles for which the diameter D95 is less than 25 μm makes it possible to reduce even more the variations in thickness of the cut slices.
To use polycrystalline diamonds makes it possible to improve the cutting power of the wire and to reduce even more the variations in thickness of the cut slices.

Another subject matter of the invention is a process for cutting slices using the claimed abrasive cutting wire.

The embodiments of this process can comprise the characteristic of the dependent claim.

A better understanding of the invention will be obtained on reading the description which will follow, given solely as nonlimiting example and made with reference to the drawings, in which:

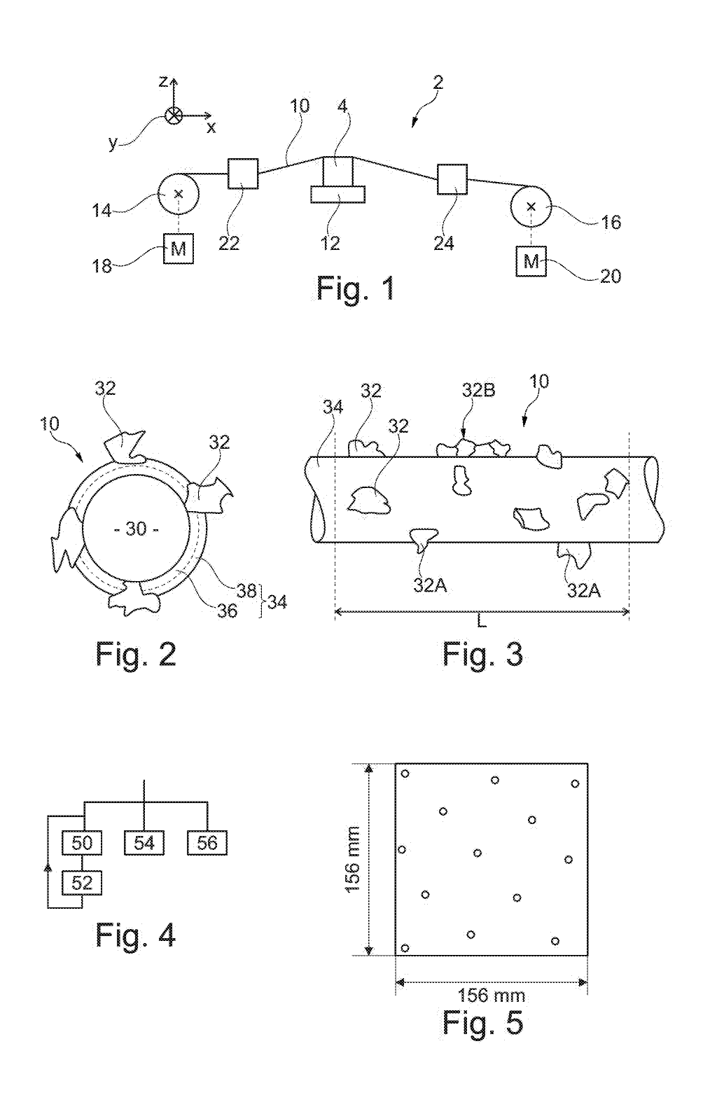

FIG. 1 is a diagrammatic illustration of a device for cutting slices from an ingot made of hard material;

FIG. 2 is a diagrammatic illustration of a cross section of an abrasive cutting wire used in the device of FIG. 1;

FIG. 3 is a diagrammatic side illustration of a portion of the abrasive cutting wire of FIG. 2;

FIG. 4 is a flow diagram of a process for cutting slices from an ingot made of hard material using the device of FIG. 1;

FIG. 5 is a diagrammatic illustration in top view of a slice cut using the device of FIG. 1.

In these figures, the same references are used to denote the same elements.

In the continuation of this description, the characteristics and functions well known to a person skilled in the art are not described in detail.

FIG. 1 represents a device 2 for cutting an ingot 4 into fine slices. The ingot 4 is a block, typically a parallelepipedal block, of a hard material. For example, the hard material is monocrystalline or polycrystalline silicon, or also sapphire or silicon carbide. In this instance, the ingot 4 is a block of monocrystalline silicon. This ingot 4 extends parallel to a horizontal direction Y. FIG. 1 is oriented with respect to an orthogonal marker XYZ, where X and Y are horizontal directions and Z is the vertical direction.

Thin slice typically denotes a slice, the thickness of which is less than 5 millimeters and generally less than 1 millimeter. These slices are better known under the term of wafer.

The devices for cutting such slices are well known and only the details necessary for the understanding of the invention are given here. For example, for further information with regard to such a device, the reader may refer to the application US20120298091.

The device 2 comprises:
an abrasive wire 10 which rubs over an upper part of the ingot 4,
an actuator 12 which displaces the ingot 4 vertically as the wire 10 cuts this ingot 4,
bobbins 14 and 16 on which the wire 10 is wound and unwound, and
motors 18 and 20 for driving in rotation the bobbins 14 and 16 respectively.

The wire 10 is intended to cut the ingot 4 by friction or abrasion. The structure of the wire 10 is described in greater detail with reference to FIGS. 2 and 3. The length of this wire 10 is generally greater than 100 m or 1000 m and usually less than 100 kilometers. In the cutting zone of the ingot 4, the wire 10 is framed around wire guides, not represented in FIG. 1, so as to obtain several sections of the wire 10 parallel to one another and which rub at the same time over the ingot 4. The space between two successive parallel sections of the wire 10 in the Y direction then defines the thickness of the cut slice.

The motors 18 and 20 drive the bobbins 14 and 16 in rotation, sometimes in one direction and sometimes in the opposite direction, so that the wire 10 is animated with a to-and-fro movement. Each bobbin 14, 16 generally comprises several turns of the wire 10 directly stacked on one another along the radial direction of this bobbin.

The wire 10 is tensioned mechanically between the bobbins 14 and 16. In this instance, the device 2 additionally comprises mechanisms 22 and 24 for adjusting tension of the wire 10. For example, these mechanisms 22 and 24 make it possible to adjust the tension of the wire 10 wound over the bobbins 14 and 16. These mechanisms 22 and 24 are, for example, identical to those described in the application US20120298091.

FIGS. 2 and 3 represent the wire 10 in more detail. It comprises a central core 30, on the periphery of which are fixed abrasive particles 32 maintained on the central core by a binder 34.

Typically, the central core 30 is provided in the form of a single wire exhibiting a tensile strength of greater than 2000 MPa or 3000 MPa and generally of less than 5000 MPa. The elongation at break of the core 30 is greater than 1% and preferably greater than 2%. Conversely, elongation at break of the core 30 should not be excessively high and, for example, should remain below 10% or 5%. The elongation at break in this instance represents the increase in the length of the core 30 before the latter breaks.

In this embodiment, the core 30 has a circular cross section. For example, the diameter of the core 30 is between 50 μm and 150 μm and often between 70 μm and 150 μm. In this example, the diameter of the core 30 is equal to 120 μm. In this instance, the core 30 is made of an electrically conductive material. It is considered that a material is electrically conductive if its resistivity is less than 10⁻⁵ Ω·m at 20° C. For example, the core 30 is made of steel, such as a carbon steel or a ferritic stainless steel or a brass-coated steel. In this example, the core 30 is made of steel comprising 0.8% by weight of carbon. The linear density m of the core 4 is, for example, between 10 mg/m and 500 mg/m and preferably between 50 mg/m and 200 mg/m.

The abrasive particles 32 form teeth at the surface of the core 30 which will erode the material to be cut. These abrasive particles thus have to be harder than the material to be cut. Typically, the abrasive particles exhibit a hardness greater by at least 30 HV or 100 HV than that of the ingot to be cut. To this end, each abrasive particle is formed of a material, the hardness of which is greater than 430 HV on the Vickers scale and preferably greater than or equal to 1000 HV. On the Mohs scale, the hardness of this material is greater than 7 or 8. Typically, this material represents more than 80% or 90% of the volume of the abrasive particle. For example, the particles 32 are diamonds. Preferably, these diamonds are polycrystalline diamonds often denoted under the acronym “RB (Resin Bond) diamonds” or monocrystalline diamonds referred to as “Hyperion”, such as those described in the application WO2011014884 and sold by Sandvik Hyperion®. The hardness of an abrasive particle can be estimated from their chemical composition and from their crystalline structure, and according to the data published with regard to the hardnesses of the different minerals.

In this embodiment, the particles 32 are Hyperion diamonds. These Hyperion diamonds exhibit the following characteristics:
they are monocrystalline,
their surface roughness is between 0.6 and 0.8, and
their sphericity is between 0.25 and 0.5.

The surface roughness and the sphericity are defined in the application WO2011014884. It should simply be recalled here that the surface roughness is a measurement, in a two-dimensional image, of the amount of holes and peaks on the ridges of an object or on the edges of this object as shown by the Clemex image analyzer (Clemex Vision User's Guide PE 3.5 ©2001). The surface roughness is determined by the ratio of the convex perimeter to the true perimeter. The sphericity is the surface area, in a two-dimensional image, of the object to its perimeter squared. Because of these properties, the Hyperion diamonds exhibit a greater specific surface than the RB diamonds. The specific surface is equal to the sum of the external surface areas of the diamonds divided by the sum of the weights of these diamonds for one and the same batch.

The sizes of the particles 32 are distributed according to probability law. In this instance, the distribution of the sizes of the particles 32 are such that:
the 5% minimum diameter of the particles 32, known as D5, is greater than 5 μm, and
the 95% maximum diameter of the particles 32, known as D95, is less than 40 μm and less than a third of the diameter of the core 30.

The diameter D95 is a value such that 95% by volume of the particles 32 of the wire 10 have a diameter of less than D95. In other words, only 5% by volume of the particles 32 of the wire 10 have a diameter of greater than D95. The diameter D5 is a value of such only 5% by volume of the particles 32 of the wire 10 have a diameter of less than D5. In other words, 95% by volume of the particles 32 of the wire 10 have a diameter of greater than D5. The diameter of the particles 32 is measured using a Coulter counter. The measurement method is described in the standard ISO 13319:2000, “Determination of particle size distribution—Electrical sensing zone method”, or the revised standard ISO 13319:2007. In order to separate the abrasive particles from the wire, the latter is immersed in an aqueous solution containing nitric acid. The metals of the core and of the binder are dissolved, while the insoluble abrasive particles are released. They are subsequently extracted and rinsed, before measuring their particle size distribution. The diameter shown corresponds to the diameter of the sphere which would behave identically during the particle size analysis by a Coulter counter.

Preferably, the diameter D95 is less than 30 μm or 25 μm. For example, advantageously, the diameter D5 is greater than 8 μm and the diameter D95 is less than or equal to 25 μm or 30 μm. In this instance, the diameter D5 is equal to 12 μm and the diameter D95 is equal to 25 μm.

The density of abrasive particles of the wire 10 is in this instance expressed in number of abrasive particles per millimeter of wire. This density of abrasive particles is measured according to the following method:

1) At least four samples with a length of more than 1 mm are withdrawn from the wire 10. These samples are withdrawn from a working section of the wire used to cut the ingot 4 and are preferably withdrawn at places uniformly distributed over this working section.
2) Each sample is inserted into a support which makes it possible both:
to hold the sample while exposing a front side of this sample to an observation device, such as an electron or optical microscope, and
to cause the sample to pivot by 180° around its longitudinal axis in order to observe the rear side of the sample which was hitherto hidden.
   3) A section of the sample with a length L is selected, where L is a length of greater than or equal to 0.9 mm and generally of less than or equal to 1 cm or 10 cm. Subsequently, the number of abrasive particles 32 visible on the front side of this selected section is counted. In order not to count twice the abrasive particles which are visible on both sides, that is to say those whose image protrudes from the edge of the sample, these abrasive particles visible on the two sides only increment the counter by 0.5, whereas the abrasive particles visible only on the front side increment the same counter by 1. In FIG. 3, two abrasive particles 32A visible on the two sides are illustrated. During this counting, an agglomerate or a cluster of several abrasive particles is counted for one only. In FIG. 3, such an agglomerate 32B of abrasive particles is illustrated. In such an agglomerate, the layers of binder covering the different abrasive particles 32 are directly in mechanical contact with one another and the assembly thus forms only a single abrasive particle.
   4) The number of diamonds in the selected section is counted but this time on the rear side. For this, the procedure is carried out in the same way as in point 3) for the rear side of the sample, after having caused this sample to pivot by 180° around its longitudinal axis.
   5) The density of abrasive particles for this sample is then obtained by dividing the accumulated total of the number of abrasive particles counted on the front and rear sides by the length L of the selected section, expressed in mm.
   6) The density of abrasive particles of the wire 10 is taken as equal to the mean of the densities of abrasive particles measured on each of the samples.

The density of particles 32 of the wire 10 is less than 31 abrasive particles per millimeter or than 25 abrasive particles per millimeter. The density of particles 32 is greater than one abrasive particle per millimeter. Preferably, this density of abrasive particles is between five abrasive particles per millimeter and twenty five or thirty one abrasive particles per millimeter. Advantageously, this density is between twenty abrasive particles per millimeter and twenty five or thirty one abrasive particles per millimeter. Industrial cutting devices typically require at least 1 km of abrasive wire and often at least 2 km of abrasive wire. Consequently, the density of particles 32 of the wire 10 is maintained within the density ranges given above over a continuous working section of the wire 10 of at least 1 km or 2 km in length. Typically, on this working section of the wire 10, the density of particles 32 is unvarying to within about plus or minus 5% or plus or minus 10%. Furthermore, preferably, this working section represents at least 50% or 80% or 90% of the total length of the wire 10.

The role of the binder 34 is to keep the abrasive particles 32 fixed without any degree of freedom to the core 30. The binder 34 is a metal binder as these binders are harder than resins and thus make it possible to more effectively keep the abrasive particles on the core 30. Thus, the hardness of the binder 32 is greater than 450 HV or 500 HV on the Vickers scale. To this end, in this instance, the binder is an alloy of nickel and cobalt, such as that described in the application FR3005592. For example, it comprises from 20% to 40% by weight of cobalt. In this example, the binder 34 comprises 70% of nickel and 30% of cobalt, these percentages being given with respect to the weight of the binder. The hardness of the binder 32 is then equal to 650 HV on the Vickers scale, to within about plus or minus 10%.

For example, in practice, the hardness of the binder is measured by instrumented nanoindentation, by following the recommendations of the standards ISO 14577-1:2002 and ISO 14577-4:2007. However, these standards cannot be rigorously followed as the impressions are generally located too close to the edges of the binder. The hardness obtained is then expressed in GPa. This value in GPa is converted into Vickers hardness by applying the model of Oliver and Pharr to the loading and unloading curves recorded. It is for this reason that the loading in grams-force is not given in the expression of the Vickers hardness. In this instance, for the measurement by nanoindentation, a Berkovich penetrator, a force of 10 mN and a duration of 15 seconds were employed.

The thickness of the binder 34 is chosen in order to have an exposure of the abrasive particles of between Emin and Emax, where Emin is strictly less than Emax. To this end, the thickness of the binder 34 is between Tbo_min and Tbo_max. In this instance, Emin is greater than or equal to 50% and preferably 65% and Emax is less than or equal to 90%. The calculation of the exposure E of an abrasive particle is described in the application WO2011014884 with reference to FIG. 3b. It should be recollected here that the exposure E of a particle is given by the following relationship: E=100*(Tco−Tbo)/Tco, where:
Tco is the shortest distance between the vertex of the particle 32 furthest from the surface of the core 30 and the projection, along a radial direction, from this vertex to the surface of the core 30, and
Tbo is the thickness of the binder 34.

In this instance, the minimum exposure Emin of the particles 32 is calculated by regarding Tco as equal to the diameter D5 and the thickness of the binder 34 as maximum, that is to say equal to Tbo_max. The maximum thickness Tbo_max of the binder 34 which makes it possible to observe the minimum exposure Emin is thus given by the following relationship: Tbo_max=D5*(1−Emin/100). Similarly, the maximum exposure Emax of the particles 34 is calculated by regarding Tco as equal to the diameter D95 and the thickness of the binder 34 as minimum, that is to say equal to Tbo_min. The minimum thickness of the binder 34 which makes it possible to observe the maximum exposure Emax is then given by the following relationship: Tbo_min=D95*(1−Emax/100). The thickness of the binder 34 is chosen between Tbo_min and Tbo_max. Thus, for abrasive particles with diameters D5 and D95 equal respectively to 8 μm and 16 μm, the thickness of the binder is chosen between 1.6 μm and 4 μm in order to obtain a mean exposure of between 50% and 90%. For particles 32, the diameters D5 and D95 of which are equal respectively to 12 μm and 25 μm, the thickness of the binder 34 is chosen between 2.5 μm and 4.5 μm in order to obtain a mean exposure of between 60% and 90%. For the tests carried out later, the thickness of the binder 34 is always chosen equal to 4 μm.

The thickness of the binder denotes its mean thickness between the particles 32. For example, in order to measure the thickness of the binder 34, the wire 10 is cut transversely at at least four different places distributed along its length. Four transverse sections of the wire 10 similar to that represented in FIG. 2 are thus obtained. On each of these sections, the thickness of the binder 34 is measured at at least four points. The measurement points are located between the particles 32. Preferably, these measurement points are uniformly distributed over the periphery of the cross section. For example, at each measurement point, the thickness is measured using an electron microscope. This is because the boundary between the core 30 and the binder 34 is visible on the sections. Subsequently, the thickness of the binder 34 is taken as equal to the mean of all the measurements obtained on each of the cross sections.

In this embodiment, the binder 34 is deposited as two successive layers 36 and 38 by electrolysis. The thickness of the layer 36 is low. It is, for example, less than a third of the median diameter of the abrasive particles. This layer 36 makes it possible only to weakly fix the particles 32 to the central core.

The layer 38 has a greater thickness. For example, the thickness of the layer 38, in the radial direction, is 1.5 or two times greater than the thickness of the layer 36.

This layer 38 makes it possible to prevent the abrasive particles 32 from being torn off when the wire 10 is used to cut the ingot 4.

The wire 10 is, for example, manufactured as described in the application FR2988629.

The process for cutting the ingot 4 using the device 2 will now be described with reference to the process of FIG. 4.

Initially, most of the wire 10 is wound onto the bobbin 14.

During a stage 50, the motors 18 and 20 are controlled in order to unroll a length L1 of wire 10 from the bobbin 14 and, at the same time, roll a length L1 of wire 10 around the bobbin 16. The wire 10 is then displaced in the direction X.

During a stage 52, once a length L1 of the wire 10 has been unrolled from the bobbin 14, the control of the motors 18 and 20 is reversed in order this time to unroll a length L2 of wire 10 from the bobbin 16 and, at the same time, roll this length L2 of wire 10 around the bobbin 14. Thus, during stage 52, the wire 10 is displaced in the opposite direction to the direction X.

When the length L2 of wire 10 has been rolled onto the bobbin 14, stage 52 is interrupted and the process returns to stage 50.

Generally, the length L2 is shorter than the length L1 so that, at each execution of stage 50, a length L1−L2 of fresh wire is injected between the two bobbins 14 and 16. Typically, the difference between L2 and L1 is less than 2% or 1.5% of the length of the wire 10. In this instance, this difference is equal to 1% of the length of the wire 10 to within approximately plus or minus 10%.

During each execution of the stages 50 and 52, the wire 10 rubs over the ingot 4, which gradually results in a saw cut being hollowed out by abrasion in the upper face of this ingot.

In parallel with stages 50 and 52, during a stage 54, the actuator 12 advances the ingot 4 in the direction Z in order to maintain good mechanical contact between the ingot 4 and the wire 10.

Also in parallel, during a stage 56, the mechanisms 22 and 24 subjugate the mechanical tension of the wire 10 to a mechanical tension set point CT. Preferably, this set point CT is chosen in order for the tension of the wire 10 on the bobbins 14 and 16 to be less than or equal to half the maximum tension before breaking withstood by this wire 10. For example, in the case of the wire 10 described here, the maximum tension before breaking is 43 N to within approximately plus or minus 15%. The mechanical tension set point is thus chosen to be less than 21.5 N. This makes it possible to increase the lifetime of the wire 10.

Tests were carried out in order to confirm that the wire 10 actually makes it possible to reduce the variations in thickness of the cut slices. For these tests, the device 2 used is the device carrying the WSD-K2 reference, sold by Takatori®.

The lubricant used to discharge the silicon grains torn off by the wire 10 is pure water.

The ingot 4 is a monocrystalline silicon parallelepiped, the cross section of which is a square with a side length of 156 mm.

The spacing between the axes of two successive parallel sections of the wire 10 in the cutting zone is 700 μm. This makes it possible to cut slices with a thickness of approximately 550 μm.

The tension of the wire 10 in the cutting zone is adjusted to 15 newtons.

The rate of vertical displacement of the ingot 4 is 0.75 mm/min, which corresponds, under steady state conditions, to the rate of cutting.

The lengths L1 and L2 are respectively equal to 116.6 m and 115.4 m.

The rate of displacement of the wire 10 during stages 50 and 52 is 500 m/min.

In each test, four slices of the ingot 4 are cut at the same time. For each test, the following physical quantities were measured:
the variation in the thickness of the slice, better known under the acronym TTV (Total Thickness Variation), expressed in micrometers,
the maximum deflection of the abrasive wire reached after cutting for 3h15, expressed in mm,
the mean thickness of the slice, expressed in micrometers,
the cutting power K of the abrasive wire, expressed in m²/N.

The variation in the thickness of a slice is measured as follows:

1) The thickness of the cut slice is measured at thirteen different points. The position of each of the measurement points is represented by a black point in FIG. 5.
2) The variation in thickness of a slice is taken as equal to the difference between the greatest and the smallest of the thicknesses measured on this slice during stage 1).
3) The variation in thickness TTV is taken as equal to the mean of the variations in thickness measured on each of the four slices cut simultaneously.

The deflection is the distance between:
the maximum height of the wire, in the Z direction, measured on the vertical edge of the ingot 4 after cutting the ingot 4 for 3h15 using this wire, and
the height of the wire at the same location under the same conditions but in the absence of the ingot 4. This deflection is representative of the cutting power K of the wire. It becomes smaller as the cutting power of the wire increases.

The cutting power K is defined by the following relationship: K=Q/(F×V), where:
Q is the throughput of sawn material,
F is the force applied by the wire perpendicularly to the surface of the sawn material, and
V is the speed of the wire.

The throughput Q of sawn material is given, for example, by the following relationship: Q=V_{z}×Y×C, where:
C is the width of the ingot 4,
Y is the width of the saw cut,
V_{z} is the vertical rate of cutting of the ingot 4, and
the symbol “x” is the multiplication symbol.

The rate V_{z} is, under steady state conditions, approximately equal to the rate of displacement of the ingot 4 in the Z direction, that is to say in this instance equal to 0.75 mm/min.

The first test was carried out with a wire, denoted “Reference” in table 1 below. This wire is the wire sold by Asahi under the reference EcoMEP® 120 10-20HC. The diameter of its central core is equal to 120 μm. The abrasive particles are diamonds with a size distribution such that the diameters D5 and D95 are respectively equal to 10 μm and 20 μm. The binder is nickel and its hardness is approximately 430 HV on the Vickers scale. The thickness of the binder is 4 μm. The density of abrasive particles is 56 abrasive particles per millimeter.

The second and third tests were carried out with a wire identical to the wire 10, except that:
the abrasive particles are RB diamonds with a size distribution such that the diameter D5 is equal to 10 μm and the diameter D95 is equal to 22 μm, and
the density of abrasive particles is 92 abrasive particles per millimeter for the second test and 21 abrasive particles per millimeter for the third test.

In table 1, this wire is denoted “RB 12-22”.

The fourth to tenth tests were carried out with a wire identical to the wire 10 and while gradually reducing the density of abrasive particles from 41 abrasive particles per millimeter down to five abrasive particles per millimeter. In table 1, these seven abrasive wires are denoted under the reference “Hyp 12-25” and only the column which contains the number of abrasive particles per millimeter makes it possible to distinguish them from one another.

TABLE 1

| | | | | Wafer | |
|---|---|---|---|---|---|
| | Diamonds/ | TTV | Deflection | thickness | K |
| | mm | (μm) | (mm) | (μm) | (m²/N) |
| Reference | 56 | 41 | 8.2 | 559 | 1.01*10⁻¹¹ |
| RB 12-22 | 92 | 55 | 9.5 | 542 | 9.81*10⁻¹² |
| RB- 12-22 | 21 | 18 | 6.5 | 551 | 1.35*10⁻¹¹ |
| Hyp 12-25 | 41 | 49.5 | 8.5 | 542 | 1.09*10⁻¹¹ |
| Hyp 12-25 | 34 | 39 | 8.2 | 552 | 1.06*10⁻¹¹ |
| Hyp 12-25 | 31 | 34 | 7.5 | 541 | 1.25*10⁻¹¹ |
| Hyp 12-25 | 25 | 21 | 7.3 | 557 | 1.15*10⁻¹¹ |
| Hyp 12-25 | 19 | 21 | 6.7 | 557 | 1.25*10⁻¹¹ |
| Hyp 12-25 | 13 | 28 | 7.2 | 556 | 1.18*10⁻¹¹ |
| Hyp 12-25 | 5 | 21 | 6.9 | 564 | 1.16*10⁻¹¹ |

The experiment results obtained during these nine tests are summarized in table 1. It is pointed out that a clear-cut decrease in the variation in thickness of the cut slices occurs as soon as the density of the abrasive particles is less than 31 abrasive particles per millimeter and preferably less than 25 abrasive particles per millimeter. It is also pointed out that the decrease in the variations in thickness of the cut slices is obtained without substantially modifying the cutting power K of the wire.

Additional tests have shown that this decrease in the variation in thickness for densities of abrasive particles of less than 31 abrasive particles per millimeter is also obtained on replacing the Hyperion diamonds by other types of diamonds, such as RB or MB (Metal Bond) diamonds. Other tests have also shown that this decrease in the variation in thickness is obtained solely when the decrease in the density of abrasive particles is combined with a binder thickness as described for the wire 10. Finally, it has also been established that what has been described here remains true also with a density of one abrasive particle per millimeter but not below.

The use of Hyperion diamond as abrasive particles makes it possible to obtain a greater cutting power K than that which would be obtained with MB (Metal Bond) diamonds. The MB diamonds and the Hyperion diamonds are monocrystalline diamonds. The RB diamonds, which are polycrystalline, make it possible, surprisingly, to obtain a greater cutting power than what is obtained with the Hyperion diamonds, as is shown in the third test.

Numerous other embodiments are possible. For example, other metal binders can be used to produce the abrasive wire. Thus, it is also possible to use binders in which the following materials or an alloy of the following materials constitute at least 90% by weight of the weight of the binder: nickel, iron and cobalt. Other examples of possible binders are described in the application FR3005592 or FR3005593.

The binder 34 can be deposited as a single layer or as two or more layers.

The core 30 can be formed of several strands intertwined together. Likewise, the core 30 can be made of other materials than steels. For example, the core 30 can also be made of a diamagnetic or paramagnetic material.

Other types of abrasive particles can be used. For example, the abrasive particles can be made of other materials than diamond. Thus, they can also be made of SiC, SiO₂, WC, Si₃N₄, boron nitride, CrO₂ or aluminum oxide. The abrasive particles can also be covered with a coating, as described in the application WO2013149965A. Monocrystalline diamonds, such as the MB diamonds, can also be used.

1: An abrasive wire for cutting slices from an ingot comprising hard material, the wire comprising:
a central core, the diameter of which is between 0.05 mm and 0.15 mm;
abrasive particles, the 5% minimum diameter of the abrasive particles of which, denoted D5, is greater than or equal to 5 μm and the 95% maximum diameter of the abrasive particles of which, denoted D95, is less than 40 μm, the diameter D5 meaning that only 5% by volume of the abrasive particles have a diameter of less than this diameter D5 and the diameter D95 meaning that 95% by volume of the abrasive particles have a diameter of less than the diameter D95, the diameter of an abrasive particle being measured with a Coulter counter and corresponding to the diameter of the sphere which would have the same volume as the abrasive particle; and
a binder which mechanically maintains the abrasive particles on the central core, the thickness of this binder being between Tbo_min and Tbo_max, where Tbo_min and Tbo_max are given by the following relationships Tbo_max=D5×(1−Emin/100) and Tho_min=D95×(1−Emax/100), where Emin and Emax are respectively greater than 50% and less than 90%,
wherein:
the hardness of the binder is greater than 450 HV on the Vickers scale, and
the number of abrasive particles per millimeter of wire is less than 31 and greater than one over at least one 1 km of the length of the wire.

2: The wire as claimed in claim 1, wherein the number of abrasive particles per millimeter of wire over more than 1 km of its length is less than twenty-five or than twenty.

3: The wire as claimed in claim 1, wherein the number of abrasive particles per millimeter is greater than five over at least one 1 km of the length of the wire.

4: The wire as claimed in claim 1, wherein the hardness of the binder is greater than 500 HV on the Vickers scale.

5: The wire as claimed in claim 1, wherein the diameter D95 of the abrasive particles is less than 30 μm or than 25 μm.

6: The wire as claimed in claim 1, wherein the diameter D5 of the abrasive particles is greater than or equal to 8 μm.

7: The wire as claimed in claim 1, wherein the abrasive particles are polycrystalline diamonds.

8: A process for cutting slices from an ingot made of hard material, the process comprising:
displacing an abrasive cutting wire by causing it to rub over the ingot and thus saw this ingot, the displacement taking place alternately in a first direction and in a second opposite direction, and, to this end, the abrasive wire being unrolled from a bobbin when it is displaced in the first direction and alternately rolled onto this bobbin when it is displaced in the second direction,
wherein the abrasive wire is the wire as claimed in claim 1.

9: The process as claimed in claim 8, wherein, at the same time as the abrasive wire rubs over the ingot, the mechanical tension of the abrasive wire which occurs is kept lower than half the mechanical tension necessary to break this abrasive wire, the mechanical tension being that of the abrasive wire rolled onto or unrolled from the bobbin.
